(19) United States
(12) Patent Application Publication
(10) Pub. No.: US 2022/0017106 A1
(43) Pub. Date: Jan. 20, 2022

(54) MOVING OBJECT CONTROL DEVICE, MOVING OBJECT CONTROL LEARNING DEVICE, AND MOVING OBJECT CONTROL METHOD

(71) Applicant: Mitsubishi Electric Corporation, Tokyo (JP)

(72) Inventors: Kei OTA, Tokyo (JP); Takashi NAMMOTO, Tokyo (JP)

(73) Assignee: Mitsubishi Electric Corporation, Tokyo (JP)

(21) Appl. No.: 17/297,881

(22) PCT Filed: Dec. 26, 2018
(86) PCT No.: PCT/JP2018/047928

§ 371 Date: May 27, 2021

(51) Int. Cl. B60W 50/00; B60W 60/00

(52) U.S. Cl. CPC B60W 50/00; B60W 60/001; B60W 2556/10; B60W 2552/20; B60W 2554/803; B60W 2554/804; B60W 2050/006

(57) ABSTRACT

A moving object control device includes: a moving object position acquiring unit acquiring moving object position information indicating a position of a moving object; a target position acquiring unit acquiring target position information indicating a target position to which the moving object is caused to travel; and a control generating unit generating a control signal indicating a control content for causing the moving object to travel toward the target position on a basis of model information indicating a model that is trained using a calculation formula for calculating a reward including a term for calculating a reward by evaluating whether or not the moving object is traveling along a reference route by referring to reference route information indicating the reference route, the moving object position information acquired by the moving object position acquiring unit, and the target position information acquired by the target position acquiring unit.

### TECHNICAL FIELD

The present invention relates to a moving object control device, a moving object control learning device, and a moving object control method.

### BACKGROUND ART

There is technology of automatically determining a travel route of a moving object on the basis of a preset rule and controlling the travel of the moving object on the basis of the determined route.

For example, Patent Literature 1 discloses a moving robot control system including: a vehicle having a moving device; a map information storage unit in which map information is stored, the map information including traveling rule information by which traveling rules for the vehicle when traveling in a predetermined traveling area are predetermined and route search cost of the predetermined traveling area is changed according to the traveling rules; a route search unit for searching for a route from a start point of traveling to an end point of traveling on the basis of the map information stored in the map information storage unit; and a travel control unit for generating a control command value of the moving device on the basis of the route obtained by the search by the route search unit.

### CITATION LIST

### Patent Literature

Patent Literature 1: Japanese Patent No. 5402057

### SUMMARY OF INVENTION

### Technical Problem

In the technique disclosed in Patent Literature 1, a discrete grid is virtually arranged on a two-dimensional plane on which a moving object travels, a reward that can be obtained when the moving object passes through each grid point is assigned, and a route is determined so that the sum of the rewards of the moving object is maximized.

However, in a case where a route is determined on the basis of a discrete grid that is virtually arranged, the route that the moving object is to travel actually is discontinuous, and thus there is a problem that control of the accelerator, the brake, the steering wheel, etc. for causing the moving object to travel becomes discontinuous.

In order to solve this problem, it is required to determine a route on a grid having a finer interval or to determine a route on a continuous plane.

However, for determining a route on a grid having a finer interval or on a continuous plane, there is a problem that the amount of calculation increases and more time is required for determining the route.

The present invention is devised for solving the above problems, and an object of the present invention is to provide a moving object control device capable of controlling a moving object so that the moving object does not take discontinuous behavior while reducing the amount of calculation.

### Solution to Problem

A moving object control device according to the present invention includes: a moving object position acquiring unit acquiring moving object position information indicating a position of a moving object; a target position acquiring unit acquiring target position information indicating a target position to which the moving object is caused to travel; and a control generating unit generating a control signal indicating a control content for causing the moving object to travel toward the target position indicated by the target position information on the basis of model information indicating a model that is trained by evaluating a reward for traveling of the moving object using a calculation formula including a term for calculating a reward for traveling of the moving object along a reference route by referring to reference route information indicating the reference route, the moving object position information acquired by the moving object position acquiring unit, and the target position information acquired by the target position acquiring unit.

### Advantageous Effects of Invention

According to the present invention, it is possible to control a moving object so that the moving object does not take discontinuous behavior while reducing the amount of calculation.

### BRIEF DESCRIPTION OF DRAWINGS

FIG. 1 is a block diagram illustrating an example of the configuration of a moving object control device according to a first embodiment.

FIGS. 2A and 2B are diagrams each illustrating an exemplary hardware configuration of a main part of the moving object control device according to the first embodiment.

FIG. 3 is a flowchart illustrating an example of processes performed by the moving object control device according to the first embodiment.

FIG. 4 is a block diagram illustrating an example of the configuration of a moving object control learning device according to the first embodiment.

FIG. 5 is a diagram illustrating an example of selecting action a* from actions aₜ that a moving object can take when the state of a moving object according to the first embodiment is in state St.

FIG. 6 is a flowchart illustrating an example of processes performed by the moving object control learning device according to the first embodiment.

FIGS. 7A, 7B, and 7C are diagrams each illustrating an example of a route that a moving object has traveled before reaching a target position.

FIG. 8 is a block diagram illustrating an example of the configuration of a moving object control device according to a second embodiment.

FIG. 9 is a flowchart illustrating an example of processes performed by the moving object control device according to the second embodiment.

### DESCRIPTION OF EMBODIMENTS

Hereinafter, embodiments of the present invention will be described in detail by referring to the drawings.

### First Embodiment

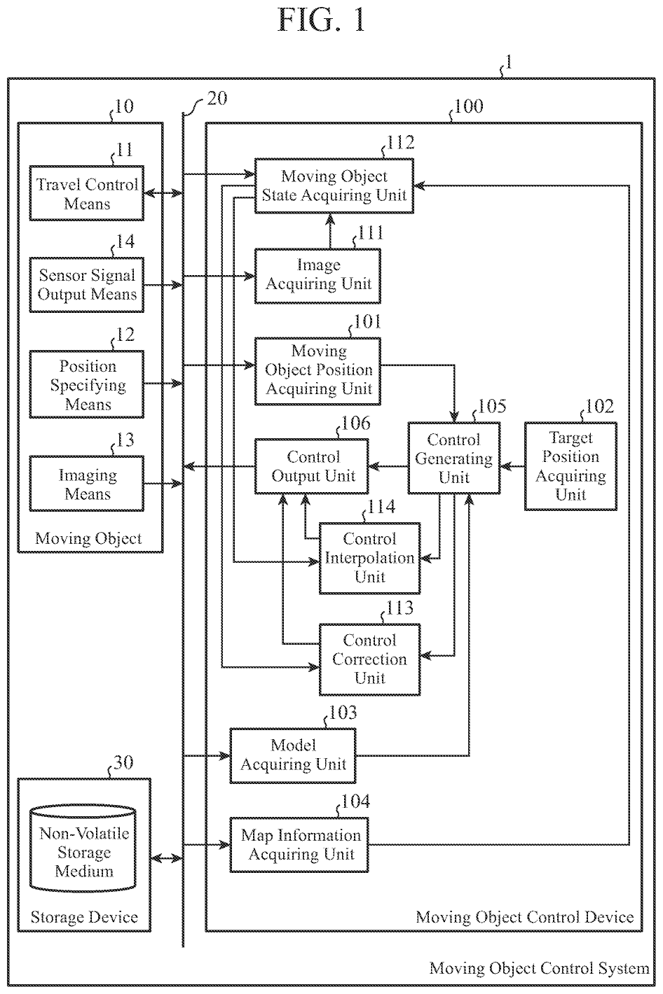

The configuration of the main part of a moving object control device 100 according to a first embodiment will be described by referring to FIG. 1.

FIG. 1 is a block diagram illustrating an example of the configuration of the moving object control device 100 according to the first embodiment.

As illustrated in FIG. 1, the moving object control device 100 is applied to a moving object control system 1.

The moving object control system 1 includes the moving object control device 100, a moving object 10, a network 20, and a storage device 30.

The moving object 10 is, for example, a self-propelled traveling device such as a vehicle that travels on a road or the like or a moving robot that travels on a passage or the like. In the first embodiment, description is given assuming that the moving object 10 is a vehicle that travels on a road.

The moving object 10 includes a travel control means 11, a position specifying means 12, an imaging means 13, and a sensor signal output means 14.

The travel control means 11 is provided for performing travel control of the moving object 10 on the basis of a control signal input thereto. The travel control means 11 includes an accelerator control means, a brake control means, a gear control means, a steering wheel control means, or the like for controlling the accelerator, the brake, the gear, the steering wheel, or the like included on the moving object 10.

For example, in a case where the travel control means 11 is an accelerator control means, the travel control means 11 controls the magnitude of power output from the engine, the motors, or the like by controlling the amount of depression of the accelerator pedal on the basis of a control signal input thereto. For example, in a case where the travel control means 11 is a brake control means, the travel control means 11 controls the magnitude of the brake pressure by controlling the amount of depression of the brake pedal on the basis of a control signal input thereto. For example, in a case where the travel control means 11 is a gear control means, the travel control means 11 performs gear change control on the basis of a control signal input thereto. For example, in a case where the travel control means 11 is a steering wheel control means, the travel control means 11 controls the steering angle of the steering wheel on the basis of a control signal input thereto.

The travel control means 11 outputs a moving object state signal indicating the current travel control state of the moving object 10.

For example, in a case where the travel control means 11 is an accelerator control means, the travel control means 11 outputs an accelerator state signal indicating the current amount of depression of the accelerator pedal. Alternatively, for example, in a case where the travel control means 11 is a brake control means, the travel control means 11 outputs a brake state signal indicating the current amount of depression of the brake pedal. Further alternatively, for example, in a case where the travel control means 11 is a gear control means, the travel control means 11 outputs a gear state signal indicating the current state of the gear. Furthermore, for example, in a case where the travel control means 11 is a steering wheel control means, the travel control means 11 outputs a steering wheel state signal indicating the current steering angle of the steering wheel.

The position specifying means 12 outputs, as moving object position information, the current position of the moving object 10 specified by using global navigation satellite system (GNSS) signals such as global positioning system (GPS) signals. The method of specifying the current position of the moving object 10 using GNSS signals is known, and thus description thereof will be omitted.

The imaging means 13 is an imaging device such as a digital video camera and outputs, as image information, an image obtained by imaging the surroundings of the moving object 10.

The sensor signal output means 14 outputs, as a moving object state signal, for example, a speed signal indicating the speed of the moving object 10, an acceleration signal indicating the acceleration of the moving object 10, or an object signal indicating an object present around the moving object 10 detected by a detection sensor such as a speed sensor, an acceleration sensor, or an object sensor included in the moving object 10.

The network 20 is a communication means including a wired network such as a controller area network (CAN) or a local area network (LAN) or a wireless network such as a wireless LAN, or the LTE (Long Term Evolution) (registered trademark).

The storage device 30 is provided for storing information necessary for the moving object control device 100 to generate a control signal indicating a control content for causing the moving object 10 to travel toward a target position. The information necessary for the moving object control device 100 to generate a control signal indicating the control content for causing the moving object 10 to travel toward a target position is, for example, model information or map information. The storage device 30 has a non-volatile storage medium such as a hard disk drive or an SD memory card and stores, in the non-volatile storage medium, information necessary for the moving object control device 100 to generate a control signal.

The travel control means 11, the position specifying means 12, the imaging means 13, and the sensor signal output means 14 included in the moving object 10, the storage device 30, and the moving object control device 100 are each connected to the network 20.

The moving object control device 100 generates a control signal indicating the control content for causing the moving object 10 to travel toward a target position on the basis of model information, moving object position information, and target position information and outputs the generated control signal to the moving object 10 via the network 20.

In the first embodiment, description is given assuming that the moving object control device 100 is installed at a remote location away from the moving object 10. The moving object control device 100 is not limited to those installed at a remote location away from the moving object 10 and may be mounted on the moving object 10.

The moving object control device 100 includes a moving object position acquiring unit 101, a target position acquiring unit 102, a model acquiring unit 103, a map information acquiring unit 104, a control generating unit 105, and a control output unit 106. In addition to the above configuration, the moving object control device 100 may further include an image acquiring unit 111, a moving object state acquiring unit 112, a control correction unit 113, and a control interpolation unit 114.

The moving object position acquiring unit 101 acquires, from the moving object 10, moving object position information indicating the position of the moving object 10. The moving object position acquiring unit 101 acquires the moving object position information from the position specifying means 12 included in the moving object 10 via the network 20.

The target position acquiring unit 102 acquires target position information indicating the target position to which the moving object 10 is caused to travel. The target position acquiring unit 102 acquires the target position information by receiving target position information input by, for example, user's operation on an input device (not illustrated).

The model acquiring unit 103 acquires model information. The model acquiring unit 103 acquires model information by reading model information from the storage device 30 via the network 20. Note that, in a case where the control generating unit 105 or another component retains the model information in advance in the first embodiment, the model acquiring unit 103 is not an essential component in the moving object control device 100.

The map information acquiring unit 104 acquires map information. The map information acquiring unit 104 acquires map information by reading map information from the storage device 30 via the network 20. Note that, in a case where the control generating unit 105 or another component retains the map information in advance in the first embodiment, the map information acquiring unit 104 is not an essential component in the moving object control device 100.

The map information is, for example, image information including obstacle information indicating the position or an area of an object with which the moving object 10 should not be in contact when traveling (hereinafter referred to as the “obstacle”). Obstacles are, for example, buildings, walls, or guardrails.

The control generating unit 105 generates a control signal indicating the control content for causing the moving object 10 to travel toward the target position indicated by the target position information, on the basis of the model information acquired by the model acquiring unit 103, the moving object position information acquired by the moving object position acquiring unit 101, and the target position information acquired by the target position acquiring unit 102.

A model indicated by the model information is obtained by training using a calculation formula for calculating a reward which includes a term for calculating the reward by evaluating whether or not the moving object 10 is traveling along a reference route by referring to reference route information indicating the reference route.

Specifically, for example, the model information includes correspondence information in which the position of the moving object 10 indicated by the moving object position information acquired by the moving object position acquiring unit 101 and control signals indicating the control content for causing the moving object 10 to travel are associated with each other. Correspondence information is information in which, for each of a plurality of target positions that are different from each other, a plurality of positions and control signals corresponding to the respective positions are paired. The model information includes a plurality of pieces of correspondence information, and each piece of correspondence information is associated with each of the plurality of target positions that are different from each other.

The control generating unit 105 specifies correspondence information corresponding to the target position indicated by the target position information acquired by the target position acquiring unit 102 from the correspondence information included in the model information and generates control information on the basis of the specified correspondence information and the moving object position information acquired by the moving object position acquiring unit 101.

More specifically, the control generating unit 105 refers to the specified correspondence information and specifies a control signal corresponding to the position indicated by the moving object position information acquired by the moving object position acquiring unit 101 and thereby generates a control signal indicating the control content for causing the moving object 10 to travel.

The control output unit 106 outputs the control signal generated by the control generating unit 105 to the moving object 10 via the network 20.

The travel control means 11 included in the moving object 10 receives the control signal output by the control output unit 106 via the network 20 and, as described above, performs travel control of the moving object 10 on the basis of the control signal, using the received control signal as an input signal.

The image acquiring unit 111 acquires, from the imaging means 13 via the network 20, image information obtained by the imaging means 13 included in the moving object 10 imaging the surroundings of the moving object 10.

Instead of acquiring moving object position information from the position specifying means 12 included in the moving object 10, the moving object position acquiring unit 101 described above may acquire moving object position information by specifying the position of the moving object 10 on the basis of, for example, the situation surrounding the moving object 10 indicated by image information obtained by analyzing the image information acquired by the image acquiring unit 111 using known image analysis techniques and information indicating the landscape along the route on which the moving object 10 travels that is included in the map information.

The moving object state acquiring unit 112 acquires a moving object state signal indicating the state of the moving object 10. The moving object state signal acquires the moving object state signal from the travel control means 11 or the sensor signal output means 14 included in the moving object 10 via the network 20.

The moving object state signal acquired by the moving object state acquiring unit 112 is, for example, an accelerator state signal, a brake state signal, a gear state signal, a steering wheel state signal, a speed signal, an acceleration signal, or an object signal.

The control correction unit 113 corrects the control signal generated by the control generating unit 105 (hereinafter referred to as the “first control signal”) so that the control content indicated by the first control signal has an amount of change within a predetermined range as compared with a control content indicated by a control signal that has been generated by the control generating unit 105 at the last time (hereinafter referred to as the “second control signal”).

For example, in a case where the control content indicated by the control signal generated by the control correction unit 113 is a control signal for controlling the steering angle of the steering wheel for changing the traveling direction of the moving object 10, the control correction unit 113 corrects the steering angle indicated by the first control signal so that the steering angle indicated by the first control signal is within a certain range as compared with the steering angle of the steering angle control indicated by the second control signal, thereby preventing a sudden steering.

Further, for example, in a case where the control content indicated by the control signal generated by the control correction unit 113 is a control signal of, for example, accelerator throttle control or brake pressure control of the brake for changing the traveling speed of the moving object 10, the control correction unit 113 corrects the control content indicated by the first control signal so that the control content indicated by the first control signal does not cause sudden acceleration nor sudden deceleration as compared with the control content indicated by the second control signal.

By providing the control correction unit 113, the moving object control device 100 can cause the moving object 10 to stably travel so that no sudden steering, sudden acceleration, sudden deceleration, or the like occurs in the moving object 10.

Note that although the example has been described in which the control correction unit 113 compares the first control signal and the second control signal, the control correction unit 113 may compare the first control signal and the moving object state signal acquired by the moving object state acquiring unit 112 and correct the first control signal so that the amount of change in the moving object 10 is within a predetermined range for the control performed by the travel control means 11.

The control content of the control signal generated by the control generating unit 105 may be one of control signals such as that of steering angle control, throttle control, and brake pressure control, or a combination of a plurality of control signals.

In a case where a part or all of the control content indicated by the first control signal generated by the control generating unit 105 is missing, the control interpolation unit 114 corrects the first control signal by interpolating a control content that is missing in the first control signal on the basis of the control content indicated by the second control signal that has been generated by the control generating unit 105 at the last time. When the control interpolation unit 114 interpolates the control content missing in the first control signal on the basis of the control content indicated by the second control signal, the first control signal is corrected by interpolating so that the control content that is missing in the first control signal has an amount of change within a predetermined range from the control content indicated by the second control signal.

For example, in a case where the control generating unit 105 periodically generates a control signal at every predetermined period and controls the moving object 10, generation of a control signal by the control generating unit 105 may not be completed within the period. In such a case, for example, in the control signal generated by the control generating unit 105, a part or all thereof is missing. For example, in a case where the control content indicated by the control signal is a control signal that specifies an absolute value instead of a relative value, if a part or all of the control content of a control signal generated by the control generating unit 105 is missing, sudden steering, sudden acceleration, sudden deceleration, or the like may occur in the moving object 10.

By providing the control interpolation unit 114, the moving object control device 100 can cause the moving object 10 to stably travel so that no sudden steering, sudden acceleration, sudden deceleration, or the like occurs in the moving object 10.

Note that although the example has been described in which the control interpolation unit 114 interpolates the first control signal on the basis of the second control signal when the control content missing in the first control signal is interpolated, the control correction unit 113 may perform correction by interpolating the first control signal so that the amount of change in the moving object 10 is within a predetermined range for the control performed by the travel control means 11 on the basis of the moving object state signal acquired by the moving object state acquiring unit 112.

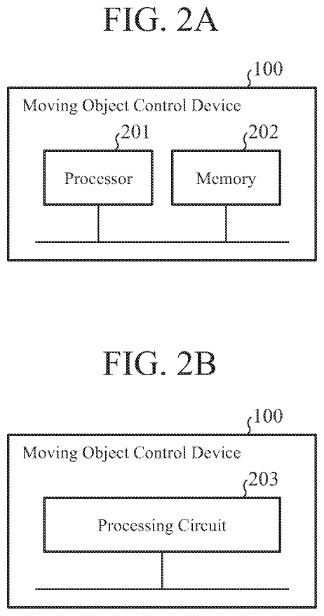

By referring to FIGS. 2A and 2B, the hardware configuration of the main part of the moving object control device 100 according to the first embodiment will be described.

FIGS. 2A and 2B are diagrams each illustrating an exemplary hardware configuration of the main part of the moving object control device 100 according to the first embodiment.

As illustrated in FIG. 2A, the moving object control device 100 includes a computer, and the computer includes a processor 201 and a memory 202. The memory 202 stores programs for causing the computer to function as the moving object position acquiring unit 101, the target position acquiring unit 102, the model acquiring unit 103, the map information acquiring unit 104, the control generating unit 105, the control output unit 106, the image acquiring unit 111, the moving object state acquiring unit 112, the control correction unit 113, and the control interpolation unit 114. Reading and executing the programs stored in the memory 202 by the processor 201 results in implementation of the moving object position acquiring unit 101, the target position acquiring unit 102, the model acquiring unit 103, the map information acquiring unit 104, the control generating unit 105, the control output unit 106, the image acquiring unit 111, the moving object state acquiring unit 112, the control correction unit 113, and the control interpolation unit 114.

Alternatively, as illustrated in FIG. 2B, the moving object control device 100 may include a processing circuit 203. In this case, the functions of the moving object position acquiring unit 101, the target position acquiring unit 102, the model acquiring unit 103, the map information acquiring unit 104, the control generating unit 105, the control output unit 106, the image acquiring unit 111, the moving object state acquiring unit 112, the control correction unit 113, and the control interpolation unit 114 may be implemented by the processing circuit 203.

Further alternatively, the moving object control device 100 may include the processor 201, the memory 202, and the processing circuit 203 (not illustrated). In this case, a part of the functions of the moving object position acquiring unit 101, the target position acquiring unit 102, the model acquiring unit 103, the map information acquiring unit 104, the control generating unit 105, the control output unit 106, the image acquiring unit 111, the moving object state acquiring unit 112, the control correction unit 113, and the control interpolation unit 114 may be implemented by the processor 201 and the memory 202, and the remaining functions may be implemented by the processing circuit 203.

As the processor 201, for example, a central processing unit (CPU), a graphics processing unit (GPU), a microprocessor, a micro controller, or a digital signal processor (DSP) is used.

As the memory 202, for example, a semiconductor memory or a magnetic disk is used. More specifically, as the memory 202, for example, a random access memory (RAM), a read only memory (ROM), a flash memory, an erasable programmable read only memory (EPROM), an electrically erasable programmable read-only memory (EEPROM), a solid state drive (SSD), or a hard disk drive (HDD) is used.

The processing circuit 203 includes, for example, an application specific integrated circuit (ASIC), a programmable logic device (PLD), a field-programmable gate array (FPGA), a system-on-a-chip (SoC), or a system large-scale integration (LSI).

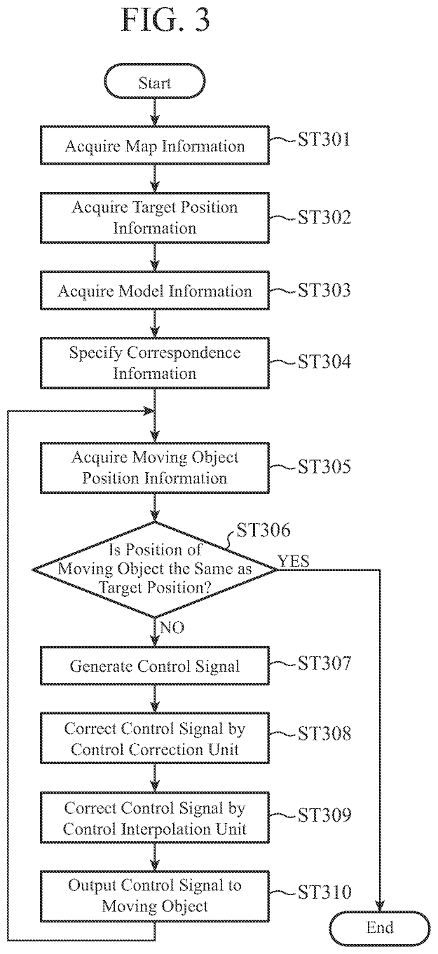

The operation of the moving object control device 100 according to the first embodiment will be described by referring to FIG. 3.

FIG. 3 is a flowchart illustrating an example of processes of the moving object control device 100 according to the first embodiment.

The moving object control device 100 repeatedly executes the processes of the flowchart every time a new target position is set, for example.

First, in step ST301, the map information acquiring unit 104 acquires map information.

Then, in step ST302, the target position acquiring unit 102 acquires target position information.

Next, in step ST303, the model acquiring unit 103 acquires model information.

Then in step ST304, the control generating unit 105 specifies correspondence information corresponding to the target position indicated by the target position information among the correspondence information included in the model information.

Next, in step ST305, the moving object position acquiring unit 101 acquires moving object position information.

Next, in step ST306, the control generating unit 105 determines whether or not the position of the moving object 10 indicated by the moving object position information and the target position indicated by the target position information are the same. Note that being the same as the meaning used herein is not necessarily exactly being the same, and the meaning of being the same includes substantially being the same.

If the control generating unit 105 determines in step ST306 that the position of the moving object 10 indicated by the moving object position information and the target position indicated by the target position information are the same, the moving object control device 100 ends the processes of the flowchart.

If the control generating unit 105 determines in step ST306 that the position of the moving object 10 indicated by the moving object position information and the target position indicated by the target position information are not the same, the control generating unit 105 generates, in step ST307, a control signal indicating the control content for causing the moving object 10 to travel by referring to the specified correspondence information and specifying the control signal that corresponds to the position indicated by the moving object position information.

Next, in step ST308, the control correction unit 113 corrects the first control signal so that the control content indicated by the first control signal generated by the control generating unit 105 has an amount of change within a predetermined range as compared with the control content indicated by the second control signal that has been generated by the control generating unit 105 at the last time.

Next, in step ST309, in a case where a part or all of the control content indicated by the first control signal generated by the control generating unit 105 is missing, the control interpolation unit 114 corrects the first control signal by interpolating the control content that is missing in the first control signal on the basis of the control content indicated by the second control signal that has been generated by the control generating unit 105 at the last time.

Next, in step ST310, the control output unit 106 outputs the control signal generated by the control generating unit 105 or the control signal corrected by the control correction unit 113 or the control interpolation unit 114 to the moving object 10.

After executing the process of step ST310, the moving object control device 100 returns to the process of step ST305 and, in step ST306, repeatedly executes the processes from step ST305 to step ST310 during the period until the time at which the control generating unit 105 determines that the position of the moving object 10 indicated by the moving object position information and the target position indicated by the target position information are the same.

Note that, in the processes of the flowchart, the processing from step ST301 to step ST303 may be executed in any order as long as these processes are executed before the process of step ST304. Moreover, in the processes of the flowchart, the processes of step ST308 and step ST309 may be executed in the reverse order.

The method of generating model information will be described.

The model information that is used when the moving object control device 100 generates a control signal is generated by a moving object control learning device 300.

The moving object control learning device 300 generates a control signal for controlling the moving object 10, performs learning for controlling the moving object 10 by controlling the moving object 10 by the control signal, and generates model information used when the moving object control device 100 controls the moving object 10.

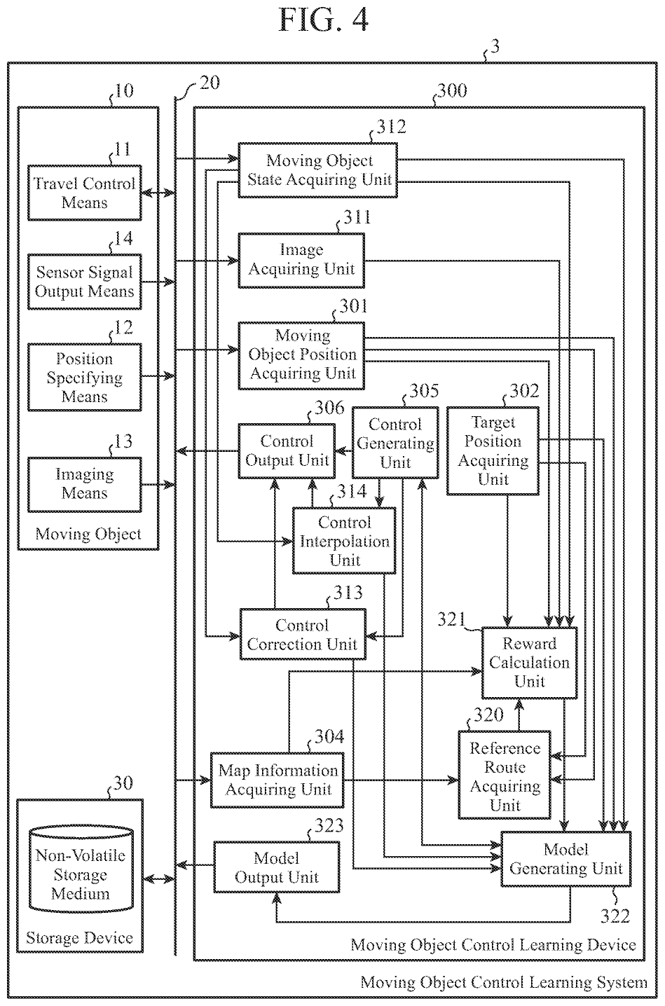

The configuration of the main part of the moving object control learning device 300 according to the first embodiment will be described by referring to FIG. 4.

FIG. 4 is a block diagram illustrating an example of the configuration of the moving object control learning device 300 according to the first embodiment.

As illustrated in FIG. 4, the moving object control learning device 300 is applied to a moving object control learning system 3.

In the configuration of the moving object control learning system 3, components similar to those of the moving object control system 1 are denoted by the same symbols, and redundant description is omitted. That is, description will be omitted for components in FIG. 4 denoted by the same symbols as those in FIG. 1.

The moving object control learning system 3 includes the moving object control learning device 300, the moving object 10, the network 20, and the storage device 30.

The travel control means 11, the position specifying means 12, the imaging means 13, and the sensor signal output means 14 included in the moving object 10, the storage device 30, and the moving object control learning device 300 are each connected to the network 20.

The moving object control learning device 300 generates model information used when a control signal is generated which indicates the control content for the moving object control device 100 to cause the moving object 10 to travel toward the target position, on the basis of the moving object position information, the target position information, and the reference route information.

In the first embodiment, description is given assuming that the moving object control learning device 300 is installed at a remote location away from the moving object 10. The moving object control learning device 300 is not limited to those installed at a remote location away from the moving object 10 and may be mounted on the moving object 10.

The moving object control learning device 300 includes a moving object position acquiring unit 301, a target position acquiring unit 302, a map information acquiring unit 304, a moving object state acquiring unit 312, a reference route acquiring unit 320, a reward calculation unit 321, a model generating unit 322, a control generating unit 305, a control output unit 306, and a model output unit 323. In addition to the above configuration, the moving object control learning device 300 may also include an image acquiring unit 311, a control correction unit 313, and a control interpolation unit 314.

Note that the functions of the moving object position acquiring unit 301, the target position acquiring unit 302, the map information acquiring unit 304, the moving object state acquiring unit 312, the reference route acquiring unit 320, the reward calculation unit 321, the model generating unit 322, the control generating unit 305, the control output unit 306, the model output unit 323, the image acquiring unit 311, the control correction unit 313, and the control interpolation unit 314 in the moving object control learning device 300 according to the first embodiment may be implemented by the processor 201 and the memory 202 in the hardware configuration exemplified in FIGS. 2A and 2B for the moving object control device 100 according to the first embodiment or may be implemented by the processing circuit 203.

The moving object position acquiring unit 301 acquires, from the moving object 10, moving object position information indicating the position of the moving object 10. The moving object position acquiring unit 301 acquires the moving object position information from the position specifying means 12 included in the moving object 10 via the network 20.

The target position acquiring unit 302 acquires target position information indicating the target position to which the moving object 10 is caused to travel. The target position acquiring unit 302 acquires the target position information by receiving target position information input by, for example, user's operation on an input device (not illustrated).

The map information acquiring unit 304 acquires map information. The map information acquiring unit 304 acquires map information by reading the map information from the storage device 30 via the network 20. Note that, in a case where the reference route acquiring unit 320, the reward calculation unit 321, or other component retains the map information in advance in the second embodiment, the map information acquiring unit 304 is not an essential component in the moving object control learning device 300.

The map information is, for example, image information including obstacle information indicating the position or an area of an object with which the moving object 10 should not be in contact when traveling (hereinafter referred to as the “obstacle”). Obstacles are, for example, buildings, walls, or guardrails.

The image acquiring unit 311 acquires, from the imaging means 13 via the network 20, image information obtained by the imaging means 13 included in the moving object 10 imaging the surroundings of the moving object 10.

Instead of acquiring moving object position information from the position specifying means 12 included in the moving object 10, the moving object position acquiring unit 301 described above may acquire moving object position information by specifying the position of the moving object 10 on the basis of, for example, the situation surrounding the moving object 10 indicated by image information obtained by analyzing the image information acquired by the image acquiring unit 311 using known image analysis techniques and information indicating the landscape along the route on which the moving object 10 travels that is included in the map information.

The moving object state acquiring unit 312 acquires a moving object state signal indicating the state of the moving object 10. The moving object state signal acquires the moving object state signal from the travel control means 11 or the sensor signal output means 14 included in the moving object 10 via the network 20.

The moving object state signal acquired by the moving object state acquiring unit 312 is, for example, an accelerator state signal, a brake state signal, a gear state signal, a steering wheel state signal, a speed signal, an acceleration signal, or an object signal.

The reference route acquiring unit 320 acquires reference route information indicating a reference route including at least a part of a route from the position of the moving object 10 indicated by the moving object position information acquired by the moving object position acquiring unit 301 to the target position indicated by the target position information acquired by the target position acquiring unit 302.

For example, the reference route acquiring unit 320 causes a display device (not illustrated) to display the map information acquired by the map information acquiring unit 304, and an input device (not illustrated) accepts input from a user to acquire reference route information input thereto.

The method of acquiring reference route information in the reference route acquiring unit 320 is not limited to the above method.

For example, the reference route acquiring unit 320 may acquire reference route information by executing random search using, for example, rapidly-exploring random tree (RRT) on the basis of the moving object position information, the target position information, and the map information and generating the reference route information on the basis of the result of the random search.

By using the result of random search when acquiring the reference route information, the reference route acquiring unit 320 can automatically generate reference route information.

Note that since the method of obtaining a route between two points by random search using, for example, RRT is known, description thereof will be omitted.

Furthermore, the reference route acquiring unit 320 may acquire reference route information by, for example, specifying a predetermined position in the width direction of a traveling lane (hereinafter referred to as the “lane”) on which the moving object 10 travels in a section from the position of the moving object 10 indicated by the moving object position information to the target position indicated by the target position information and generating reference route information on the basis of the specified position in the width direction of the lane.

The predetermined position in the width direction of a lane is, for example, the center in the width direction of the lane. The center in the width direction of a lane does not need to be the exact center in the width direction of the lane and includes the vicinity of the center. Furthermore, the center in the width direction of a lane is merely an example of the predetermined position in the width direction of the lane, and the predetermined position in the width direction of the lane is not limited to the center in the width direction of the lane.

The width of a lane is specified by the reference route acquiring unit 320, for example, on the basis of the map information or image information such as an aerial image that allows the shape of the lane included in the map information to be specified.

By using the predetermined position in the width direction of the traveling lane when acquiring the reference route information, the reference route acquiring unit 320 can automatically generate reference route information.

In addition, for example, the reference route acquiring unit 320 may acquire reference route information by, for example, generating reference route information on the basis of travel history information indicating routes that the moving object 10 has traveled in the past or other history information indicating routes that another moving object (not illustrated), which is different from the moving object 10, has traveled in the past, in the section from the position of the moving object 10 indicated by the moving object position information to the target position indicated by the target position information.

The travel history information indicates, for example, discrete positions of the moving object 10 in the section that have been specified by the position specifying means 12 included in the moving object 10 using GNSS signals such as GPS signals when the moving object 10 has traveled in the section before. The position specifying means 12 included in the moving object 10 stores in advance the travel history information in the storage device 30 via the network 20 when, for example, the moving object 10 travels in the section. The reference route acquiring unit 320 acquires travel history information by reading the travel history information from the storage device 30.

Similarly, other history information indicates, for example, discrete positions of another moving object in the section that have been specified by a position specifying means 12 included in the other moving object using GNSS signals such as GPS signals when the other moving object has traveled in the section before. The position specifying means 12 included in the other moving object has stored the other history information in the storage device 30 via the network 20 when, for example, the other moving object has traveled in the section before. The reference route acquiring unit 320 acquires the other history information by reading the other history information from the storage device 30.

Note that in a case where the position specifying means 12 included in the other moving object stores the other history information in the storage device 30 via the network 20 and the reference route acquiring unit 320 included in the moving object 10 reads the other history information from the storage device 30 via the network 20, it is understood without explaining in detail that the storage device 30 is configured so as to be accessible via the network 20 from, for example, the position specifying means 12 included in the other moving object and the reference route acquiring unit 320 included in the moving object 10.

The reference route acquiring unit 320 generates reference route information by connecting the discrete positions of the moving object 10 or the other moving object in the section indicated by the travel history information or the other history information by a straight-line segment or a curve.

By using the travel history information or the other history information when acquiring the reference route information, the reference route acquiring unit 320 can automatically generate reference route information.

The reward calculation unit 321 calculates a reward using a calculation formula including a term for calculating the reward by evaluating whether or not the moving object 10 is traveling along the reference route on the basis of the moving object position information acquired by the moving object position acquiring unit 301, the target position information acquired by the target position acquiring unit 302, and the reference route information acquired by the reference route acquiring unit 320.

The calculation formula used by the reward calculation unit 321 to calculate the reward may further include, in addition to the term for calculating a reward by evaluating whether or not the moving object 10 is traveling along the reference route, a term for calculating a reward by evaluating the state of the moving object 10 indicated by the moving object state signal acquired by the moving object state acquiring unit 312 or a term for calculating a reward by evaluating the action of the moving object 10 on the basis of the state of the moving object 10. The moving object state signal indicating the state of the moving object 10 used for calculation of the reward is, for example, an accelerator state signal, a brake state signal, a gear state signal, a steering wheel state signal, a speed signal, an acceleration signal, or an object signal.

Further, the calculation formula used by the reward calculation unit 321 for calculating the reward may further include, in addition to the term for calculating a reward by evaluating whether or not the moving object 10 is traveling along the reference route, a term for calculating a reward by evaluating a relative position between the moving object 10 and an obstacle. The reward calculation unit 321 acquires the relative position between the moving object 10 and the obstacle by using, for example, an object signal acquired by the moving object state acquiring unit 312. The reward calculation unit 321 may acquire the relative position between the moving object 10 and the obstacle by analyzing image information obtained by imaging the surroundings of the moving object 10 acquired by the image acquiring unit 311 by a known image analysis method. Alternatively, the reward calculation unit 321 may acquire the relative position between the moving object 10 and the obstacle by comparing the position or an area of the obstacle indicated by obstacle information included in the map information acquired by the map information acquiring unit 304 and the position of the moving object 10 indicated by the moving object position information acquired by the moving object position acquiring unit 301.

Specifically, the reward calculation unit 321 calculates a reward using the following Expression (1) when the moving object 10 acts from the state of the moving object 10 at time point t−1 to time point t on the basis of any control signal and becomes the state of the moving object 10 at time point t. The period from time point t−1 to time point t is, for example, a predetermined time interval in which the control generating unit 305 generates a control signal to be output to the moving object 10.

Rₜ=w₁d_{goal}+w₂+w₃II_{goal}+w₄II_{collision}+w₅|\ddot{x}ₜ|+w₆d_{reference}+w₇n_{index} Expression (1)

Here, Rt denotes a reward at time point t.

d_{goal} denotes a value indicating the distance between the target position indicated by the target position information and the position of the moving object 10 indicated by the moving object position information at time point t. The first term w₁d_{goal} is the reward based on the distance. w₁ is a predetermined coefficient.

The second term w₂ denotes a penalty for the elapse of time from time point t−1 to time point t and is a negative value in Expression (1) for calculating the reward.

II_{goal} is a binary value represented by, for example, either 0 or 1 that indicates whether or not the moving object 10 has reached the target position. The third term w₃II_{goal} is the reward as of a time point when the moving object 10 has reached the target position. In a case where the moving object 10 has not reached the target position at time point t, the value of the third term w₃II_{goal} is 0. w₃ is a predetermined coefficient.

II_{collision} is a binary value represented by, for example, either 0 or 1 that indicates whether or not the moving object 10 has contacted an obstacle. The fourth term w₄II_{collision} is the penalty for the fact that the moving object 10 has contacted an obstacle and is a negative value in Expression (1) for calculating the reward. In a case where the moving object 10 has not contacted an obstacle at time point t, the value of the fourth term w₄II_{collision} is 0. Note that w₄ is a predetermined coefficient.

|\ddot{x}ₜ| denotes the absolute value of the acceleration of the moving object 10 at time point t. The fifth term w₅|\ddot{x}ₜ| is the penalty for the absolute value of the acceleration of the moving object 10 and is a negative value in Expression (1) for calculating the reward. The fifth term w₅|\ddot{x}ₜ| gives a larger penalty as the absolute value of the acceleration of the moving object 10 increases, and thus, as a result, the value of Rₜ which is the reward calculated by Expression (1) decreases as the absolute value of the acceleration of the moving object 10 increases. w₅ is a predetermined coefficient.

d_{reference} denotes a value indicating the distance between the position of the moving object 10 at time point t and a reference route. The sixth term w₆d_{reference} is a penalty for the distance between the position of the moving object 10 and the reference route and is a negative value in Expression (1) for calculating the reward. The sixth term w₆d_{reference} gives a larger penalty as the distance between the position of the moving object 10 and the reference route increases, and thus, as a result, the value of Rₜ which is the reward calculated by Expression (1) decreases as the distance between the position of the moving object 10 and the reference route increases. w₆ is a predetermined coefficient.

n_{index} denotes a value indicating the distance that the moving object 10 has traveled along the reference route in the direction toward the target position when time has elapsed from time point t−1 to time point t. The seventh term w₇n_{index} is a reward corresponding to the distance that the moving object 10 has traveled along the reference route in the direction toward the target position when time has elapsed from time point t−1 to time point t. w₇ is a predetermined coefficient.

The model generating unit 322 generates a model by reinforcement learning such as temporal difference (TD) learning such as Q-learning, Actor-Critic, or SARSA learning or the Monte Carlo method and generates model information indicating the generated model.

In reinforcement learning, value Q (Sₜ, aₜ) for a certain action at when the certain action at is selected out of one or more actions that the action subject can take in state Sₜ of the action subject at certain time point t and reward rₜ for the certain action at are defined, and value Q (Sₜ, aₜ) and reward rₜ are enhanced.

In general, an update formula of an action value function is expressed by the following Expression (2).

Q(Sₜ,aₜ)←Q(Sₜ,aₜ)+α(rₜ₊₁+γ max Q(Sₜ₊₁,aₜ₊₁)−Q(Sₜ,aₜ)) Expression (2)

Here, Sₜ denotes the state of the action subject at a certain time point t, aₜ denotes the action of the action subject at a certain time point t, and Sₜ₊₁ denotes the state of the action subject at time point t+1 at which the time has advanced by a predetermined time interval from time point t. The action subject in state Sₜ at time point t transitions to state Sₜ₊₁ at time point t+1 by action aₜ.

Q (Sₜ, aₜ) represents the value for action aₜ performed by the action subject in state Sₜ.

rₜ₊₁ denotes a value indicating the reward when the action subject transitions from state Sₜ to state Sₜ₊₁.

maxQ (Sₜ₊₁, aₜ₊₁) represents Q (Sₜ₊₁, a*) in a case where the action subject selects action a* that maximizes the value of Q (Sₜ₊₁, aₜ₊₁) from among the actions aₜ₊₁ that the action subject can take when the state of the action subject is state Sₜ₊₁.

γ is a parameter indicating a positive value less than or equal to 1 and is a value generally called a discount rate.

α is a learning coefficient indicating a positive value less than or equal to 1.

Expression (2) is used for updating value Q (Sₜ, aₜ) of action at performed by the action subject in state Sₜ of the action subject on the basis of reward rₜ₊₁ based on action at performed by the action subject in state Sₜ of the action subject and value Q (Sₜ₊₁, a*) of action a* performed by the action subject in state Sₜ₊₁ of the action subject transitioned by action aₜ.

Specifically, Expression (2) is used to perform updating so as to increase value Q (Sₜ, aₜ) in a case where the sum of reward rₜ₊₁ based on action at in state Sₜ and value Q (Sₜ₊₁, a*) of action a* in state Sₜ₊₁ transitioned to by action at is larger than value Q (Sₜ, aₜ) by action aₜ in state Sₜ. On the contrary, Expression (2) is used to perform updating so as to reduce value Q (Sₜ, aₜ) in a case where the sum of reward rₜ₊₁ based on action at in state Sₜ and value Q (Sₜ₊₁, a*) of action a* in state Sₜ₊₁ transitioned to by action aₜ is smaller than value Q (Sₜ, aₜ) by action aₜ in state Sₜ.

That is, Expression (2) is used to perform updating so as to bring the value of an action as of the time when the action subject performs the action in a case where the action subject is in a certain state closer to the sum of a reward based on the action and the value of the best action in a state transitioned to by the action.

Of actions aₜ₊₁ that the action subject can take when the state of the action subject is state Sₜ₊₁, a method for the action subject to determine action a* that maximizes the value of Q (Sₜ₊₁, aₜ₊₁) is, for example, a method using the epsilon-greedy algorithm, the Softmax function, or the radial basis function (RBF). These methods are known, and thus description thereof will be omitted.

In the above general Expression (2), the action subject is the moving object 10 according to the first embodiment, the state of the action subject is the state of the moving object 10 indicated by the moving object state signal acquired by the moving object state acquiring unit 312 according to the first embodiment or the position of the moving object 10 indicated by the moving object position information acquired by the moving object position acquiring unit 301, and the action is the control content for causing the moving object 10 to travel that is indicated by the control signal generated by the control generating unit 305 according to the first embodiment.

The model generating unit 322 generates model information by applying the Expression (1) to Expression (2). The model generating unit 322 generates correspondence information in which the position of the moving object 10 indicated by the moving object position information acquired by the moving object position acquiring unit 301 and control signals indicating the control content for causing the moving object 10 to travel are associated with each other. Correspondence information is information in which, for each of a plurality of target positions that are different from each other, a plurality of positions and control signals corresponding to the respective positions are paired. The model generating unit 322 generates model information including a plurality of pieces of correspondence information associated with each of a plurality of target positions different from each other.

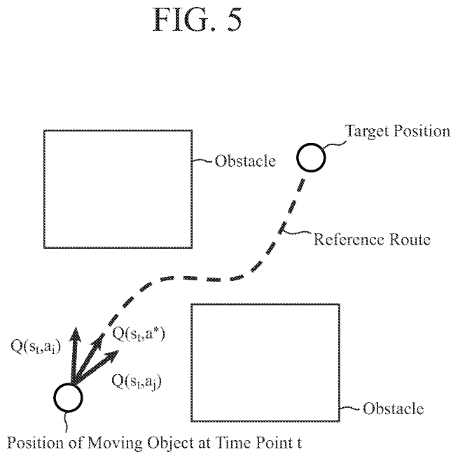

A method of selecting action a* from actions aₜ that the moving object 10 can take when the state of the moving object 10 according to the first embodiment is state Sₜ will be described by referring to FIG. 5.

FIG. 5 is a diagram illustrating an example of selecting action a* from actions aₜ that the moving object 10 can take when the state of the moving object 10 according to the first embodiment is state Sₜ.

In FIG. 5, aᵢ, aⱼ, and a* are actions that the moving object 10 can take when the state of the moving object 10 is state Sₜ at time point t. Q (Sₜ, aᵢ), Q (Sₜ, aⱼ), and Q (Sₜ, a*) are values for the respective actions when the moving object 10 takes action aᵢ, action aⱼ, and action a* when the state of the moving object 10 is state Sₜ.

The model generating unit 322 generates model information by applying Expression (1) to Expression (2), and thus value Q (Sₜ, aᵢ), value Q (Sₜ, aⱼ), and value Q (Sₜ, a*) are evaluated by the calculation formula including the sixth and seventh terms in Expression (1). That is, value Q (Sₜ, aᵢ), value Q (Sₜ, aⱼ), and value Q (Sₜ, a*) have higher values as the distance between the position of the moving object 10 and the reference route is closer and as the distance that the moving object 10 has traveled along the reference route toward the target position is longer.

Therefore, when value Q (Sₜ, aᵢ), value Q (Sₜ, aⱼ), and value Q (Sₜ, a*) are compared, value Q (Sₜ, a*) has the highest value, and thus the model generating unit 322 selects action a* when the state of the moving object 10 is state Sₜ and generates model information by associating state Sₜ with a control signal that corresponds to action a*.

Note that it is preferable that the model generating unit 322 use TD learning that can reduce the number of times of trials for determining the above-mentioned action a* by adopting an appropriate calculation formula for calculating the reward when generating model information.

The control generating unit 305 generates a control signal corresponding to the action selected by the model generating unit 322 when generating the model information.

The control output unit 306 outputs the control signal generated by the control generating unit 305 to the moving object 10 via the network 20.

The travel control means 11 included in the moving object 10 receives the control signal output by the control output unit 306 via the network 20 and, as described above, performs travel control of the moving object 10 on the basis of the control signal, using the received control signal as an input signal.

The model output unit 323 outputs the model information generated by the model generating unit 322 to the storage device 30 via the network 20 and stores the model information in the storage device 30.

The control correction unit 313 corrects the control signal generated by the control generating unit 305 (hereinafter referred to as the “first control signal”) so that the control content indicated by the first control signal has an amount of change within a predetermined range as compared with the control content indicated by the control signal that has been generated by the control generating unit 305 at the last time (hereinafter referred to as the “second control signal”).

Note that although the example has been described in which the control correction unit 313 compares the first control signal and the second control signal; the control correction unit 313 may compare the first control signal and the moving object state signal acquired by the moving object state acquiring unit 312 and correct the first control signal so that the amount of change in the moving object 10 is within a predetermined range for the control performed by the travel control means 11.

Since the operation of the control correction unit 313 is similar to the operation of the control correction unit 113 in the moving object control device 100, detailed description thereof will be omitted.

Note that the model generating unit 322 may generate model information using the control signal corrected by the control correction unit 313.

In a case where a part or all of the control content indicated by the first control signal generated by the control generating unit 305 is missing, the control interpolation unit 314 corrects the first control signal by interpolating a control content that is missing in the first control signal on the basis of the control content indicated by the second control signal that has been generated by the control generating unit 305 at the last time. When the control interpolation unit 314 interpolates the control content missing in the first control signal on the basis of the control content indicated by the second control signal, the first control signal is corrected by interpolating so that the control content that is missing in the first control signal has an amount of change within a predetermined range from the control content indicated by the second control signal.

Note that although the example has been described in which the control interpolation unit 314 interpolates the first control signal on the basis of the second control signal when the control content missing in the first control signal is interpolated, the control interpolation unit 314 may perform correction by interpolating the first control signal so that the amount of change in the moving object 10 is within a predetermined range for the control performed by the travel control means 11 on the basis of the moving object state signal acquired by the moving object state acquiring unit 312.

Since the operation of the control interpolation unit 314 is similar to the operation of the control interpolation unit 114 in the moving object control device 100, detailed description thereof will be omitted.

Note that the model generating unit 322 may generate model information using the control signal corrected by the control interpolation unit 314.

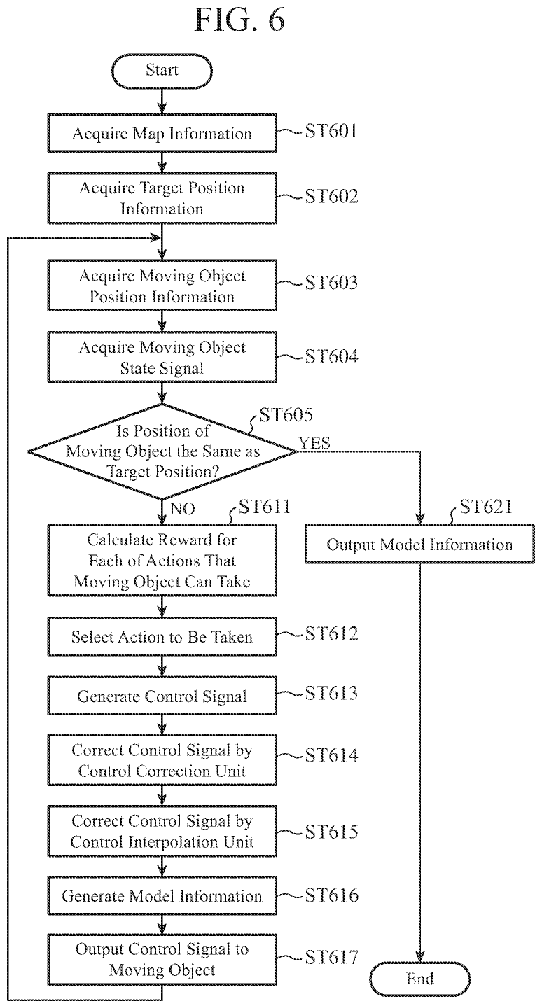

The operation of the moving object control learning device 300 according to the first embodiment will be described by referring to FIG. 6.

FIG. 6 is a flowchart illustrating an example of processes of the moving object control learning device 300 according to the first embodiment.

The moving object control learning device 300 repeatedly executes, for example, processes of the flowchart.

First, in step ST601, the map information acquiring unit 304 acquires map information.

Further, in step ST602, the target position acquiring unit 302 acquires target position information.

Next, in step ST603, the moving object position acquiring unit 301 acquires moving object position information.

Next, in step ST604, the moving object state acquiring unit 312 acquires a moving object state signal.

Next, in step ST605, the control generating unit 305 determines whether or not the position of the moving object 10 indicated by the moving object position information and the target position indicated by the target position information are the same.

If the control generating unit 305 determines in step ST605 that the position of the moving object 10 indicated by the moving object position information and the target position indicated by the target position information are not the same, the moving object control learning device 300 executes the processes of step ST611 and subsequent steps.

In step ST611, the reward calculation unit 321 calculates a reward for each of a plurality of actions that the moving object 10 can take.

Next, in step ST612, the model generating unit 322 selects an action to be taken on the basis of the reward calculated by the reward calculation unit 321 for each of actions, the value for each of the actions, and the value for each of a plurality of actions that can be taken next for each of the actions.

Next, in step ST613, the control generating unit 305 generates a control signal that corresponds to the action selected by the model generating unit 322.

Next, in step ST614, the control correction unit 313 corrects the first control signal so that the control content indicated by the first control signal generated by the control generating unit 305 has an amount of change within a predetermined range as compared with the control content indicated by the second control signal that has been generated by the control generating unit 305 at the last time.

Next, in step ST615, in a case where a part or all of the control content indicated by the first control signal generated by the control generating unit 305 is missing, the control interpolation unit 314 corrects the first control signal by interpolating the control content that is missing in the first control signal on the basis of the control content indicated by the second control signal that has been generated by the control generating unit 305 at the last time.

Next, in step ST616, the model generating unit 322 generates model information by generating correspondence information in which the position of the moving object 10 indicated by the moving object position information acquired by the moving object position acquiring unit 301 and the control signal generated by the control generating unit 305 or the control signal corrected by the control correction unit 313 or the control interpolation unit 314 are associated with each other.

Next, in step ST617, the control output unit 306 outputs the control signal generated by the control generating unit 305 or the control signal corrected by the control correction unit 313 or the control interpolation unit 314 to the moving object 10.

After executing the process of step ST617, the moving object control learning device 300 returns to the process of step ST603 and, in step ST605, repeatedly executes the processes from step ST603 to step ST617 during the period until the time at which the control generating unit 305 determines that the position of the moving object 10 indicated by the moving object position information and the target position indicated by the target position information are the same.

If the control generating unit 305 determines in step ST605 that the position of the moving object 10 indicated by the moving object position information and the target position indicated by the target position information are the same, the model output unit 323 outputs the model information generated by the model generating unit 322 in step ST621.

After the process of step ST621 is executed, the moving object control learning device 300 ends the processes of the flowchart.

Note that, in the processes of the flowchart, the processes of step ST601 and step ST602 may be executed in the reverse order. Moreover, in the processes of the flowchart, the processes of step ST614 and step ST615 may be executed in the reverse order.

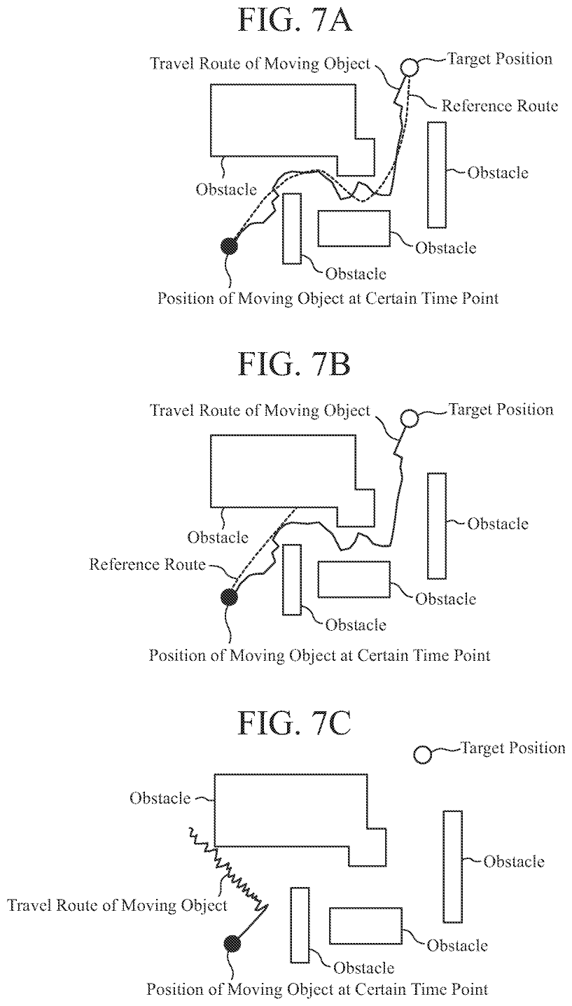

FIG. 7 show diagrams illustrating examples of a route that the moving object 10 has traveled before reaching a target position. Illustrated in FIG. 7A is a case where a reference route is set from the position of the moving object 10 at a certain time point to a target position and the calculation formula expressed in Expression (1) is used, illustrated in FIG. 7B is a case where a reference route is set from the position of the moving object 10 at a certain time point to a passing point on the way to the target position and the calculation formula expressed in Expression (1) is used, and illustrated in FIG. 7C is a case where a calculation formula obtained by removing the sixth and seventh terms from the calculation formula expressed in Expression (1) is used without setting a reference route.

It is illustrated in FIG. 7A that the moving object 10 travels along the reference route that has been set until the moving object 10 reaches the target position. Further, it is illustrated in FIG. 7B that the moving object 10 travels along the reference route to the point where there is the reference route that has been set and then travels toward the target position. On the other hand, it is illustrated in FIG. 7C that the moving object 10 cannot reach the target position since the moving object 10 travels so as to avoid obstacles when traveling toward the target position. That is, the moving object control learning device 300 can complete learning in a short period of time by setting a reference route as illustrated in FIGS. 7A and 7B and performing learning using the calculation formula expressed in Expression (1).

As described above, the moving object control device 100 includes: a moving object position acquiring unit 101 acquiring moving object position information indicating a position of a moving object 10; a target position acquiring unit 102 acquiring target position information indicating a target position to which the moving object 10 is caused to travel; and a control generating unit 105 generating a control signal indicating a control content for causing the moving object 10 to travel toward the target position indicated by the target position information on a basis of model information indicating a model that is trained using a calculation formula for calculating a reward including a term for calculating a reward by evaluating whether or not the moving object 10 is traveling along a reference route by referring to reference route information indicating the reference route, the moving object position information acquired by the moving object position acquiring unit 101, and the target position information acquired by the target position acquiring unit 102.

With this configuration, the moving object control device 100 can control the moving object 10 so that the moving object 10 does not take substantially discontinuous behavior while reducing the amount of calculation.

Furthermore, as described above, the moving object control learning device 300 includes: a moving object position acquiring unit 301 acquiring moving object position information indicating a position of a moving object 10; a target position acquiring unit 302 acquiring target position information indicating a target position to which the moving object 10 is caused to travel; a reference route acquiring unit 320 acquiring reference route information indicating a reference route; a reward calculation unit 321 calculating a reward using a calculation formula including a term for calculating a reward by evaluating whether or not the moving object 10 is traveling along the reference route on a basis of the moving object position information acquired by the moving object position acquiring unit 301, the target position information acquired by the target position acquiring unit 302, and the reference route information acquired by the reference route acquiring unit 320; a control generating unit generating a control signal indicating a control content for causing the moving object 10 to travel toward the target position indicated by the target position information; and a model generating unit 322 generating model information by evaluating a value of causing the moving object 10 to travel by the control signal on a basis of the moving object position information acquired by the moving object position acquiring unit 301, the target position information acquired by the target position acquiring unit 302, the control signal generated by the control generating unit 305, and the reward calculated by the reward calculation unit 321.

With this configuration, the moving object control learning device 300 can generate model information for controlling the moving object 10 in a short learning period so that the moving object 10 does not take substantially discontinuous behavior.

### Second Embodiment

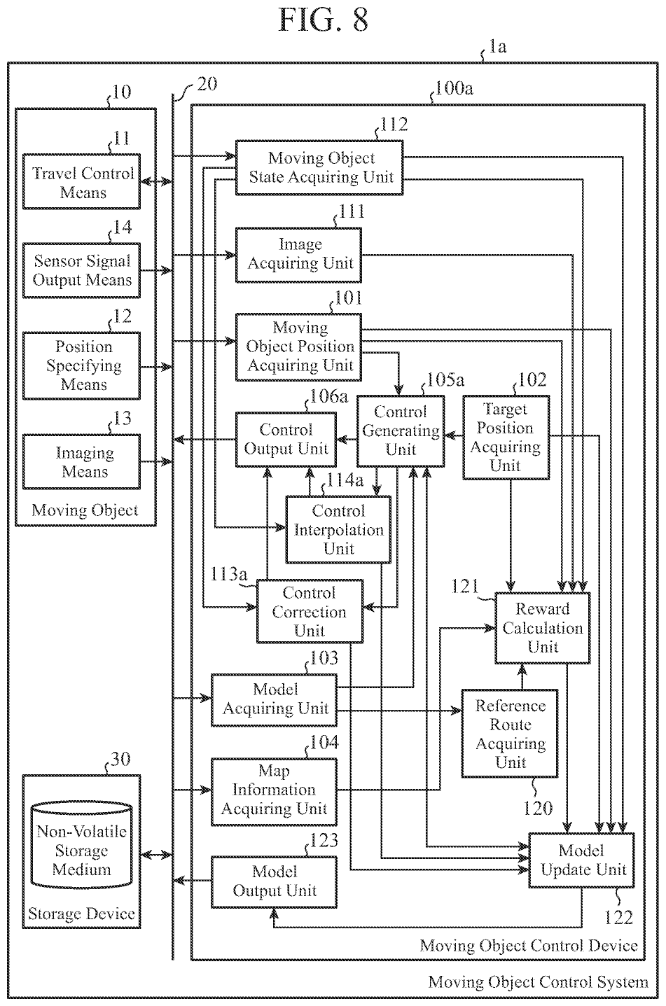

A moving object control device 100a according to a second embodiment will be described by referring to FIG. 8.

FIG. 8 is a block diagram illustrating an example of the main part of the moving object control device 100a according to the second embodiment.

As illustrated in FIG. 8, the moving object control device 100a is applied to, for example, a moving object control system 1a.

Similarly to the moving object control device 100, the moving object control device 100a generates a control signal indicating the control content for causing a moving object 10 to travel toward a target position, on the basis of model information, moving object position information, and target position information and outputs the generated control signal to the moving object 10 via a network 20. The model information that is used when the moving object control device 100a generates a control signal is generated by a moving object control learning device 300.

As compared with the moving object control device 100 according to the first embodiment, the moving object control device 100a according to the second embodiment is added with a reference route acquiring unit 120, a reward calculation unit 121, a model update unit 122, and a model output unit 123 and is capable of updating model information that has been trained and output by the moving object control learning device 300.

In the configuration of the moving object control device 100a according to the second embodiment, a component similar to that in the moving object control device 100 or the moving object control system 1 of the first embodiment is denoted with the same symbol, and redundant description will be omitted. That is, description will be omitted for components in FIG. 8 denoted by the same symbols as those in FIG. 1.

The moving object control system 1a includes the moving object control device 100a, a moving object 10, a network 20, and a storage device 30.

A travel control means 11, a position specifying means 12, an imaging means 13, and a sensor signal output means 14 included in the moving object 10, the storage device 30, and the moving object control device 100a are each connected to the network 20.

The moving object control device 100a includes a moving object position acquiring unit 101, a target position acquiring unit 102, a model acquiring unit 103, a map information acquiring unit 104, a control generating unit 105a, a control output unit 106a, a moving object state acquiring unit 112, the reference route acquiring unit 120, the reward calculation unit 121, the model update unit 122, and the model output unit 123. In addition to the above configuration, the moving object control device 100a may further include an image acquiring unit 111, a control correction unit 113a, and a control interpolation unit 114a.

Note that the functions of the moving object position acquiring unit 101, the target position acquiring unit 102, the model acquiring unit 103, the map information acquiring unit 104, the control generating unit 105a, the control output unit 106a, the moving object state acquiring unit 112, the reference route acquiring unit 120, the reward calculation unit 121, the model update unit 122, the model output unit 123, the image acquiring unit 111, the control correction unit 113a, and the control interpolation unit 114a in the moving object control device 100a according to the second embodiment may be implemented by the processor 201 and the memory 202 in the hardware configuration exemplified in FIGS. 2A and 2B in the first embodiment or may be implemented by the processing circuit 203.

The reference route acquiring unit 120 acquires reference route information indicating a reference route. Specifically, for example, the reference route acquiring unit 120 acquires reference route information by reading, from model information acquired by the model acquiring unit 103, reference route information used by the moving object control learning device 300 for generating model information.

The reward calculation unit 121 calculates a reward using a calculation formula including a term for calculating a reward by evaluating whether or not the moving object 10 is traveling along a reference route by referring to reference route information indicating the reference route, on the basis of moving object position information acquired by the moving object position acquiring unit 101, target position information acquired by the target position acquiring unit 102, and the reference route information acquired by the reference route acquiring unit 120.

The calculation formula used by the reward calculation unit 121 to calculate the reward may further include, in addition to the term for calculating a reward by evaluating whether or not the moving object 10 is traveling along the reference route, a term for calculating a reward by evaluating the state of the moving object 10 indicated by the moving object state signal acquired by the moving object state acquiring unit 112 or a term for calculating a reward by evaluating the action of the moving object 10 on the basis of the state of the moving object 10.

Further, the calculation formula used by the reward calculation unit 121 for calculating the reward may further include, in addition to the term for calculating a reward by evaluating whether or not the moving object 10 is traveling along the reference route, a term for calculating a reward by evaluating a relative position between the moving object 10 and an obstacle.

Specifically, for example, the reward calculation unit 121 specifies the position of the moving object 10 having traveled by the control signal output by the control output unit 106a using the moving object position information acquired by the moving object position acquiring unit 101 and specifies the state of the moving object 10 having traveled by the control signal using the moving object state signal acquired by the moving object state acquiring unit 112, and thereby calculates the reward on the basis of Expression (1) described in the first embodiment using the specified position and state of the moving object 10.

The model update unit 122 updates the model information on the basis of the moving object position information acquired by the moving object position acquiring unit 101, the target position information acquired by the target position acquiring unit 102, the moving object state signal acquired and generated by the moving object state acquiring unit 112, and the reward calculated by the reward calculation unit 121.

Specifically, for example, the model update unit 122 updates the model information by applying Expression (1) to Expression (2) described in the first embodiment and thereby updating the correspondence information in which the position of the moving object 10 indicated by the moving object position information acquired by the moving object position acquiring unit 101 and control signals indicating the control content for causing the moving object 10 to travel are associated with each other.

The model output unit 123 outputs the model information updated by the model update unit 122 to the storage device 30 via the network 20 and stores the model information in the storage device 30.

The control generating unit 105a generates a control signal indicating the control content for causing the moving object 10 to travel toward the target position indicated by the target position information, on the basis of the model information acquired by the model acquiring unit 103 or the model information updated by the model update unit 122, the moving object position information acquired by the moving object position acquiring unit 101, and the target position information acquired by the target position acquiring unit 102. Since the control generating unit 105a is similar to the control generating unit 105 described in the first embodiment except for that there are cases where a control signal is generated on the basis of the model information updated by the model update unit 122 instead of model information acquired by the model acquiring unit 103, detailed description thereof will be omitted.

The control correction unit 113a corrects the first control signal so that the control content indicated by the first control signal generated by the control generating unit 105a has an amount of change within a predetermined range as compared with the control content indicated by the second control signal that has been generated by the control generating unit 105a at the last time.

In a case where a part or all of the control content indicated by the first control signal generated by the control generating unit 105a is missing, the control interpolation unit 114a corrects the first control signal by interpolating a control content that is missing in the first control signal on the basis of the control content indicated by the second control signal that has been generated by the control generating unit 105a at the last time.

Note that the operation of the control correction unit 113a and the control interpolation unit 114a is similar to the operation of the control correction unit 113 and the control interpolation unit 114 illustrated in the first embodiment, detailed description thereof will be omitted.

Furthermore, the model update unit 122 may update the model information using a control signal corrected by the control correction unit 113a or the control interpolation unit 114a.

The control output unit 106a outputs the control signal generated by the control generating unit 105a or the control signal corrected by the control correction unit 113a or the control interpolation unit 114a to the moving object 10.

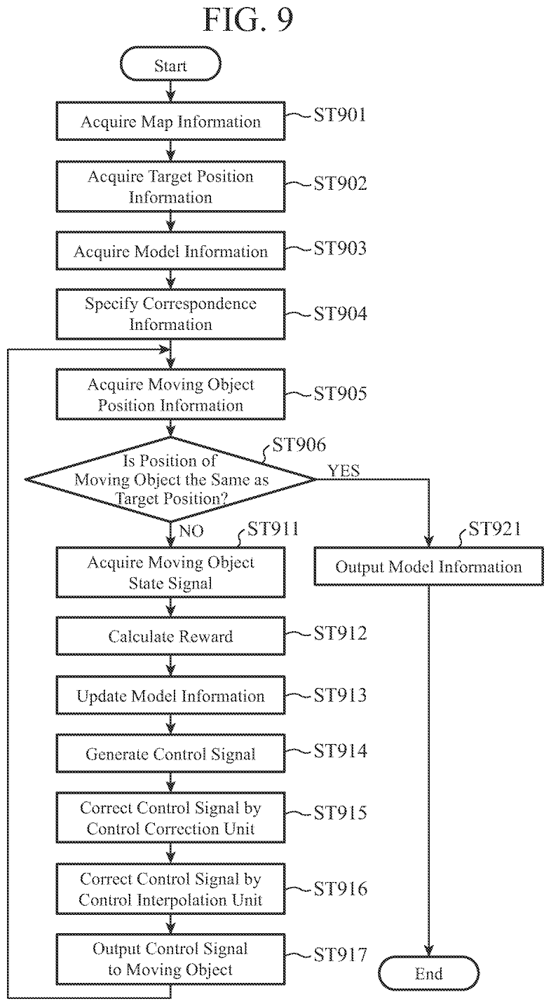

The operation of the moving object control device 100a according to the second embodiment will be described by referring to FIG. 9.

FIG. 9 is a flowchart illustrating an example of processes of the moving object control device 100a according to the second embodiment.

For example, the moving object control device 100a repeatedly executes the processes of the flowchart every time a new target position is set.

First, in step ST901, the map information acquiring unit 104 acquires map information.

Further, in step ST902, the target position acquiring unit 102 acquires target position information.

Next, in step ST903, the model acquiring unit 103 acquires model information.

Then in step ST904, the control generating unit 105a specifies correspondence information corresponding to the target position indicated by the target position information among the correspondence information included in the model information.

Next, in step ST905, the moving object position acquiring unit 101 acquires moving object position information.

Next, in step ST906, the control generating unit 105a determines whether or not the position of the moving object 10 indicated by the moving object position information and the target position indicated by the target position information are the same.

If the control generating unit 105a determines in step ST906 that the position of the moving object 10 indicated by the moving object position information and the target position indicated by the target position information are not the same, in step ST911, the moving object state acquiring unit 112 acquires a moving object state signal.

Next, in step ST912, the reward calculation unit 121 calculates the reward.

Next, in step ST913, the model update unit 122 updates the model information by updating the correspondence information specified by the control generating unit 105a.

Next, in step ST914, the control generating unit 105a refers to the correspondence information updated by the model update unit 122, specifies the control signal that corresponds to the position indicated by the moving object position information, and thereby generates a control signal indicating the control content for causing the moving object 10 to travel.

Next, in step ST915, the control correction unit 113a corrects the first control signal so that the control content indicated by the first control signal generated by the control generating unit 105a has an amount of change within a predetermined range as compared with the control content indicated by the second control signal that has been generated by the control generating unit 105a at the last time.

Next, in step ST916, in a case where a part or all of the control content indicated by the first control signal generated by the control generating unit 105a is missing, the control interpolation unit 114a corrects the first control signal by interpolating the control content that is missing in the first control signal on the basis of the control content indicated by the second control signal that has been generated by the control generating unit 105a at the last time.

Next, in step ST917, the control output unit 106a outputs the control signal generated by the control generating unit 105a or the control signal corrected by the control correction unit 113a or the control interpolation unit 114a to the moving object 10.

After executing the process of step ST917, the moving object control device 100a returns to the process of step ST905 and, in step ST906, repeatedly executes the processes from step ST905 to step ST917 during the period until the time at which the control generating unit 105a determines that the position of the moving object 10 indicated by the moving object position information and the target position indicated by the target position information are the same.

If the control generating unit 105a determines in step ST906 that the position of the moving object 10 indicated by the moving object position information and the target position indicated by the target position information are the same, the model output unit 123 outputs the model information updated by the model update unit 122 in step ST921.

After executing the process of step ST921, the moving object control device 100a ends the processes of the flowchart.

Note that, in the processes of the flowchart, the processes from step ST901 to step ST903 may be executed in any order as long as the processes are executed before the process of step ST904. Moreover, in the processes of the flowchart, the processes of step ST915 and step ST916 may be executed in the reverse order.

As described above, the moving object control device 100a includes: a moving object position acquiring unit 101 acquiring moving object position information indicating a position of a moving object 10; a target position acquiring unit 102 acquiring target position information indicating a target position to which the moving object 10 is caused to travel; a control generating unit 105a generating a control signal indicating a control content for causing the moving object to travel toward the target position indicated by the target position information on a basis of model information indicating a model that is trained using a calculation formula for calculating a reward including a term for calculating a reward by evaluating whether or not the moving object 10 is traveling along a reference route by referring to reference route information indicating the reference route, the moving object position information acquired by the moving object position acquiring unit 101, and the target position information acquired by the target position acquiring unit 102; a reference route acquiring unit 120 acquiring the reference route information indicating the reference route; a moving object state acquiring unit 112 acquiring a moving object state signal indicating a state of the moving object 10; a reward calculation unit 121 calculating a reward using a calculation formula including a term for calculating a reward by evaluating whether or not the moving object 10 is traveling along the reference route by referring to the reference route information indicating the reference route on a basis of the moving object position information acquired by the moving object position acquiring unit 101, the target position information acquired by the target position acquiring unit 102, the reference route information acquired by the reference route acquiring unit 120, and the moving object state signal acquired by the moving object state acquiring unit 112; and a model update unit 122 updating the model information on a basis of the moving object position information acquired by the moving object position acquiring unit 101, the target position information acquired by the target position acquiring unit 102, the moving object state signal acquired and generated by the moving object state acquiring unit 112, and the reward calculated by the reward calculation unit 121.

With this configuration, by evaluating whether or not the moving object 10 is traveling along a reference route by referring to the reference route information indicating the reference route, the moving object control device 100a can control the moving object 10 with higher accuracy so that the moving object 10 does not take substantially discontinuous behavior while updating the model information generated by the moving object control learning device 300 in a short time with a small amount of calculation.

Note that the present invention may include a flexible combination of the embodiments, a modification of any component of the embodiments, or an omission of any component in the embodiments within the scope of the present invention.

### INDUSTRIAL APPLICABILITY

A moving object control device according to the present invention is applicable to a moving object control system. Further, a moving object control learning device according to the present invention is applicable to a moving object control learning system.

### REFERENCE SIGNS LIST

1, 1a: moving object control system, 10: moving object, 11: travel control means, 12: position specifying means, 13: imaging means, 14: sensor signal output means, 20: network, 30: storage device, 100, 100a: moving object control device, 101: moving object position acquiring unit, 102: target position acquiring unit, 103: model acquiring unit, 104: map information acquiring unit, 105, 105a: control generating unit, 106, 106a: control output unit, 111: image acquiring unit, 112: moving object state acquiring unit, 113, 113a: control correction unit, 114, 114a: control interpolation unit, 120: reference route acquiring unit, 121: reward calculation unit, 122: model update unit, 123: model output unit, 3: moving object control learning system, 300: moving object control learning device, 301: moving object position acquiring unit, 302: target position acquiring unit, 304: map information acquiring unit, 305: control generating unit, 306: control output unit, 311: image acquiring unit, 312: moving object state acquiring unit, 313: control correction unit, 314: control interpolation unit, 320: reference route acquiring unit, 321: reward calculation unit, 322: model generating unit, 323: model output unit, 201: processor, 202: memory, 203: processing circuit

1. A moving object control device comprising a processing circuitry
to acquire moving object position information indicating a position of a moving object,
to acquire target position information indicating a target position to which the moving object is caused to travel, and
to generate a control signal indicating a control content for causing the moving object to travel toward the target position indicated by the target position information on a basis of model information indicating a model that is trained using a calculation formula for calculating a reward including a term for calculating a reward by evaluating whether or not the moving object is traveling along a reference route by referring to reference route information indicating the reference route, the moving object position information, and the target position information.

2. The moving object control device according to claim 1,
wherein the calculation formula further includes, in addition to the term for calculating the reward by evaluating whether or not the moving object is traveling along the reference route, a term for calculating a reward when the moving object is controlled by a control signal by evaluating a state of the moving object.

3. The moving object control device according to claim 1,
wherein the calculation formula further includes, in addition to the term for calculating the reward by evaluating whether or not the moving object is traveling along the reference route, a term for calculating a reward by evaluating a relative position between the moving object and an obstacle.

4. The moving object control device according to claim 1,
wherein the reference route information is generated on a basis of a result of random search.

5. The moving object control device according to claim 1,
wherein the reference route information is generated on a basis of a predetermined position in a width direction of a traveling lane on which the moving object travels.

6. The moving object control device according to claim 1,
wherein the reference route information is generated on a basis of travel history information indicating a route that the moving object has traveled before or other history information indicating a route that another moving object that is different from the moving object has traveled before.

7. The moving object control device according to claim 1, the processing circuitry further performing
to correct a first control signal generated as the control signal so that a control content indicated by the first control signal has an amount of change within a predetermined range as compared with a control content indicated by a second control signal that has been generated as the control signal at a last time.

8. The moving object control device according to claim 1, the processing circuitry further performing
to correct a first control signal generated as the control signal by interpolating a control content that is missing in the first control signal so that an amount of change of the first control signal is within a predetermined range from a control content indicated by a second control signal that has been generated as the control signal at a last time on a basis of a control content indicated by the second control signal in a case where a part or all of a control content indicated by the first control signal is missing.

9. The moving object control device according to claim 1, the processing circuitry further performing
to acquire the reference route information indicating the reference route,
to acquire a moving object state signal indicating a state of the moving object,
to calculate a reward using a calculation formula including a term for calculating a reward by evaluating whether or not the moving object is traveling along the reference route by referring to the reference route information indicating the reference route on a basis of the moving object position information, the target position information, the reference route information, and the moving object state signal, and
to update the model information on a basis of the moving object position information, the target position information, the moving object state signal, and the reward.

10. A moving object control learning device comprising a processing circuitry
to acquire moving object position information indicating a position of a moving object,
to acquire target position information indicating a target position to which the moving object is caused to travel,
to acquire reference route information indicating a reference route,
to calculate a reward using a calculation formula including a term for calculating a reward by evaluating whether or not the moving object is traveling along the reference route on a basis of the moving object position information, the target position information, and the reference route information,
to generate a control signal indicating a control content for causing the moving object to travel toward the target position indicated by the target position information, and
to generate model information by evaluating a value of causing the moving object to travel by the control signal on a basis of the moving object position information, the target position information, the control signal, and the reward.

11. The moving object control learning device according to claim 10, the processing circuitry further performing
to acquire a moving object state signal indicating a state of the moving object,
wherein the calculation formula further includes, in addition to the term for calculating the reward by evaluating whether or not the moving object is traveling along the reference route, a term for calculating a reward by evaluating the state of the moving object indicated by the moving object state signal or a term for calculating a reward by evaluating an action of the moving object based on the state of the moving object.

12. The moving object control learning device according to claim 10,
wherein the calculation formula further includes, in addition to the term for calculating the reward by evaluating whether or not the moving object is traveling along the reference route, a term for calculating a reward by evaluating a relative position between the moving object and an obstacle.

13. The moving object control learning device according to claim 10,
wherein the reference route information is generated on a basis of a result of random search.

14. The moving object control learning device according to claim 10,
wherein the reference route information is generated on a basis of a predetermined position in a width direction of a traveling lane on which the moving object travels.

15. The moving object control learning device according to claim 10,
wherein the reference route information is generated on a basis of travel history information indicating a route that the moving object has traveled before or other history information indicating a route that another moving object that is different from the moving object has traveled before.

16. The moving object control learning device according to claim 10, the processing circuitry further performing
to correct a first control signal generated as the control signal so that a control content indicated by the first control signal has an amount of change within a predetermined range as compared with a control content indicated by a second control signal that has been generated as the control signal at a last time.

17. The moving object control learning device according to claim 10, the processing circuitry further performing
to correct a first control signal generated as the control signal by interpolating a control content that is missing in the first control signal so that an amount of change of the first control signal is within a predetermined range from a control content indicated by a second control signal that has been generated as the control signal at a last time on a basis of a control content indicated by the second control signal in a case where a part or all of a control content indicated by the first control signal is missing.

18. A moving object control method comprising:
acquiring moving object position information indicating a position of a moving object;
acquiring target position information indicating a target position to which the moving object is caused to travel; and
generating a control signal indicating a control content for causing the moving object to travel toward the target position indicated by the target position information on a basis of model information indicating a model that is trained using a calculation formula for calculating a reward including a term for calculating a reward by evaluating whether or not the moving object is traveling along a reference route by referring to reference route information indicating the reference route, the moving object position information, and the target position information.
